(19) United States
(12) Patent Application Publication
(10) Pub. No.: US 2026/0059362 A1
(43) Pub. Date: Feb. 26, 2026

(54) DEVICES, METHODS, APPARATUSES, AND COMPUTER READABLE MEDIA FOR NON-TERRESTRIAL NETWORKS

(71) Applicant: Nokia Technologies Oy, Espoo (FI)

(72) Inventors: Mads LAURIDSEN, Aalborg (DK); Xiang XU, Beijing (CN); Ping YUAN, Beijing (CN); Jeroen WIGARD, Aalborg (DK); Hannu Petri HIETALAHTI, Oulu (FI)

(21) Appl. No.: 18/997,578

(22) PCT Filed: Sep. 29, 2022
(86) PCT No.: PCT/CN2022/122416

§ 371 Date: Jan. 22, 2025

(51) Int. Cl. H04W 24/10; H04W 4/029; H04W 64/00

(52) U.S. Cl. CPC H04W 24/10; H04W 4/029; H04W 64/00

(57) ABSTRACT

Disclosed are devices, methods, apparatuses, and computer readable media for coverage window prediction. An example terminal device may include at least one processor and at least one memory. The at least one memory may store instructions that, when executed by the at least one processor, may cause the terminal device at least to perform: receiving from a network device, information on a predicted coverage window and measurement information relating to the predicted coverage window, the measurement information comprising one or more expected measurement values; performing, according to the predicted coverage window, at least one measurement according to the measurement information; and determining whether the predicted coverage window is accurate or inaccurate based on a value of the performed at least one measurement and the corresponding at least one expected measurement value from the one or more expected measurement values.

### TECHNICAL FIELD

Various example embodiments relate to devices, methods, apparatuses, and computer readable media for non-terrestrial networks (NTN).

### BACKGROUND

A NTN is a network or a segment of a network that uses satellites, airborne vehicles, or spaceborne vehicles for transmission. Due to the cost of the satellite or airborne vehicles or spaceborne vehicles, a NTN network may not be able to provide continuous coverage, especially at its early deployment stage. The coverage for a given place on earth is discontinuous. Therefore, the user equipment (UE) side and the network side need a common understanding on when the UE is available for communication again, for example, when will the UE monitor for paging. With development of communication technology, more and more Internet of Things (IoT) communication scenarios may relate to a NTN in which terminal devices may connect to a core network (CN) via satellites or drones. The narrowband IoT (NB-IoT) and/or enhanced machine type communication (eMTC) devices are cost sensitive and energy-sensitive. These UE devices are required to work for years without changing the battery, and usually transmit/receive a small size of application data (for example, 50 bytes) from every a few hours to every a few days. As a solution, the UE may predict a future coverage window based on e.g. system information block (SIB) 32, which may provide information on up to four satellites, and report the predicted coverage window to the network, e.g. the CN. According to this solution, the UE has to provide a new or updated coverage window each time a new satellite is able to provide coverage. However, if the UE on average is paged e.g. once every 12 or 24 hours, the UE is forced to provide many coverage window predictions to the network, which in the end may probably not be used by the network, resulting in a waste of UE energy consumption and signaling.

### SUMMARY

A brief summary of exemplary embodiments is provided below to provide basic understanding of some aspects of various embodiments. It should be noted that this summary is not intended to identify key features of essential elements or define scopes of the embodiments, and its sole purpose is to introduce some concepts in a simplified form as a preamble for a more detailed description provided below.

In a first aspect, disclosed is a terminal device. The terminal device may include at least one processor and at least one memory. The at least one memory may store instructions that, when executed by the at least one processor, may cause the terminal device at least to perform: receiving from a network device, information on a predicted coverage window and measurement information relating to the predicted coverage window, the measurement information comprising one or more expected measurement values; performing, according to the predicted coverage window, at least one measurement according to the measurement information; and determining whether the predicted coverage window is accurate or inaccurate based on a value of the performed at least one measurement and the corresponding at least one expected measurement value from the one or more expected measurement values.

In some example embodiments, the instructions, when executed by the at least one processor, may cause the terminal device to further perform: transmitting to the network device, a request for the predicted coverage window, the request comprising at least one of the following: a number of at least one satellite to serve the terminal device; a number of one or more satellites to serve the terminal device before the predicted coverage window is to start; a duration to be covered by the predicted coverage window; a period after which the predicted coverage window is to start; a timing after which the predicted coverage window is to start; or a communication pattern of the terminal device.

In some example embodiments, the instructions, when executed by the at least one processor, may cause the terminal device to further perform: transmitting to the network device, positioning information of the terminal device, the positioning information comprising at least one of the following: current location information of the terminal device; information on a current serving cell of the terminal device; a mapped cell identifier of the current serving cell of the terminal device; or a travel itinerary of the terminal device.

In some example embodiments, the measurement information may further comprise at least one of the following: one or more timings for performing corresponding one or more expected measurements; one or more indexes corresponding to the one or more expected measurements; or at least one threshold for determining whether the predicted coverage window is accurate or inaccurate.

In some example embodiments, the one or more expected measurement values may comprise at least one of the following: a timing of a downlink signal; a received power of a downlink signal; a round trip time between the terminal device and a reference point; a one way delay between the terminal device and a reference point; a start timing of the predicted coverage window; an end timing of the predicted coverage window; or information of an expected cell, and the predicted coverage window may be determined to be inaccurate in at least one case of the following: where a difference between the value of the performed at least one measurement and the corresponding at least one expected measurement value exceeds a corresponding threshold; or where information of a serving cell from the performed at least one measurement is different from the information of the expected cell.

In some example embodiments, the instructions, when executed by the at least one processor, may cause the terminal device to further perform: transmitting to the network device. an inaccuracy indication indicating that the predicted coverage window is inaccurate, in a case where the predicted coverage window is determined to be inaccurate.

In some example embodiments, the inaccuracy indication may comprise at least one of the following: a flag indicating that the predicted coverage window is inaccurate; the difference between the value of the performed at least one measurement and the corresponding at least one expected measurement value; the value of the performed at least one measurement; the timing of the performed at least one measurement; the index corresponding to the performed at least one measurement; the information of the serving cell of the terminal device; or current location information of the terminal device.

In some example embodiments, the inaccuracy indication may be transmitted via an early data transmission procedure or a small data transmission procedure.

In some example embodiments, the instructions, when executed by the at least one processor, may cause the terminal device to further perform: remaining in a radio resource control idle state or a radio resource control inactive state in a case where the predicted coverage window is determined to be accurate.

In some example embodiments, the instructions, when executed by the at least one processor, may cause the terminal device to further perform: transmitting to the network device, another request for an updated predicted coverage window in at least one case of the following: observing a change of a location of the terminal device; or determining the predicted coverage window to be inaccurate.

In a second aspect, disclosed is a network device. The network device may include at least one processor and at least one memory. The at least one memory may store instructions that, when executed by the at least one processor, may cause the network device at least to perform: determining for a terminal device a predicted coverage window and measurement information relating to the predicted coverage window; and transmitting to the terminal device, information on the predicted coverage window and the measurement information relating to the predicted coverage window, the measurement information comprising one or more expected measurement values for the terminal device to determine whether the predicted coverage window is accurate or inaccurate.

In some example embodiments, the instructions, when executed by the at least one processor, may cause the network device to further perform: receiving from the terminal device, a request for the predicted coverage window, the request comprising at least one of the following: a number of at least one satellite to serve the terminal device; a number of one or more satellites to serve the terminal device before the predicted coverage window is to start; a duration to be covered by the predicted coverage window; a period after which the predicted coverage window is to start; a timing after which the predicted coverage window is to start; or a communication pattern of the terminal device.

In some example embodiments, the predicted coverage window may be determined based on at least one of the following: satellite movement information; satellite coverage information; current location information on the terminal device; information on a current serving cell of the terminal device; a mapped cell identifier of the current serving cell of the terminal device; a travel itinerary of the terminal device; or information on a communication pattern of the terminal device.

In some example embodiments, the measurement information may further comprise at least one of the following: one or more timings for performing corresponding one or more expected measurements; one or more indexes corresponding to the one or more expected measurements; or at least one threshold for determining whether the predicted coverage window is accurate or inaccurate.

In some example embodiments, the one or more expected measurement values may comprise at least one of the following: a timing of a downlink signal; a received power of a downlink signal; a round trip time between the terminal device and a reference point; a one way delay between the terminal device and a reference point; a start timing of the predicted coverage window; an end timing of the predicted coverage window; or information of an expected cell.

In some example embodiments, the instructions, when executed by the at least one processor, may cause the network device to further perform: determining for the terminal device an updated predicted coverage window in at least one case of the following: detecting that the terminal device performs a tracking area update; or receiving from the terminal device, an inaccuracy indication indicating that the predicted coverage window is inaccurate.

In some example embodiments, the inaccuracy indication may comprise at least one of the following: a flag indicating that the predicted coverage window is inaccurate; a difference between a value of at least one measurement performed by the terminal device and a corresponding at least one expected measurement value in the measurement information; a value of the at least one measurement performed by the terminal device; a timing of the at least one measurement performed by the terminal device; an index corresponding to the at least one measurement performed by the terminal device; information of a serving cell of the terminal device; or current location information of the terminal device.

In a third aspect, disclosed is a method performed by a terminal device. The method may comprise: receiving from a network device, information on a predicted coverage window and measurement information relating to the predicted coverage window, the measurement information comprising one or more expected measurement values; performing, according to the predicted coverage window, at least one measurement according to the measurement information; and determining whether the predicted coverage window is accurate or inaccurate based on a value of the performed at least one measurement and the corresponding at least one expected measurement value from the one or more expected measurement values.

In some example embodiments, the method may further comprise: transmitting to the network device, a request for the predicted coverage window, the request comprising at least one of the following: a number of at least one satellite to serve the terminal device; a number of one or more satellites to serve the terminal device before the predicted coverage window is to start; a duration to be covered by the predicted coverage window; a period after which the predicted coverage window is to start; a timing after which the predicted coverage window is to start; or a communication pattern of the terminal device.

In some example embodiments, the method may further comprise: transmitting to the network device, positioning information of the terminal device, the positioning information comprising at least one of the following: current location information of the terminal device; information on a current serving cell of the terminal device; a mapped cell identifier of the current serving cell of the terminal device; or a travel itinerary of the terminal device.

In some example embodiments, the measurement information may further comprise at least one of the following: one or more timings for performing corresponding one or more expected measurements; one or more indexes corresponding to the one or more expected measurements; or at least one threshold for determining whether the predicted coverage window is accurate or inaccurate.

In some example embodiments, the one or more expected measurement values may comprise at least one of the following: a timing of a downlink signal; a received power of a downlink signal; a round trip time between the terminal device and a reference point; a one way delay between the terminal device and a reference point; a start timing of the predicted coverage window; an end timing of the predicted coverage window; or information of an expected cell, and the predicted coverage window may be determined to be inaccurate in at least one case of the following: where a difference between the value of the performed at least one measurement and the corresponding at least one expected measurement value exceeds a corresponding threshold; or where information of a serving cell from the performed at least one measurement is different from the information of the expected cell.

In some example embodiments, the method may further comprise: transmitting to the network device, an inaccuracy indication indicating that the predicted coverage window is inaccurate, in a case where the predicted coverage window is determined to be inaccurate.

In some example embodiments, the inaccuracy indication may comprise at least one of the following: a flag indicating that the predicted coverage window is inaccurate; the difference between the value of the performed at least one measurement and the corresponding at least one expected measurement value; the value of the performed at least one measurement; the timing of the performed at least one measurement; the index corresponding to the performed at least one measurement; the information of the serving cell of the terminal device; or current location information of the terminal device.

In some example embodiments, the inaccuracy indication may be transmitted via an early data transmission procedure or a small data transmission procedure.

In some example embodiments, the method may further comprise: remaining in a radio resource control idle state or a radio resource control inactive state in a case where the predicted coverage window is determined to be accurate.

In some example embodiments, the method may further comprise: transmitting to the network device, another request for an updated predicted coverage window in at least one case of the following: observing a change of a location of the terminal device; or determining the predicted coverage window to be inaccurate.

In a fourth aspect, disclosed is a method performed by a network device. The method may comprise: determining for a terminal device a predicted coverage window and measurement information relating to the predicted coverage window; and transmitting to the terminal device, information on the predicted coverage window and the measurement information relating to the predicted coverage window, the measurement information comprising one or more expected measurement values for the terminal device to determine whether the predicted coverage window is accurate or inaccurate.

In some example embodiments, the method may further comprise: receiving from the terminal device, a request for the predicted coverage window, the request comprising at least one of the following: a number of at least one satellite to serve the terminal device; a number of one or more satellites to serve the terminal device before the predicted coverage window is to start; a duration to be covered by the predicted coverage window; a period after which the predicted coverage window is to start; a timing after which the predicted coverage window is to start; or a communication pattern of the terminal device.

In some example embodiments, the predicted coverage window may be determined based on at least one of the following: satellite movement information; satellite coverage information; current location information on the terminal device; information on a current serving cell of the terminal device; a mapped cell identifier of the current serving cell of the terminal device; a travel itinerary of the terminal device; or information on a communication pattern of the terminal device.

In some example embodiments, the measurement information may further comprise at least one of the following: one or more timings for performing corresponding one or more expected measurements; one or more indexes corresponding to the one or more expected measurements; or at least one threshold for determining whether the predicted coverage window is accurate or inaccurate.

In some example embodiments, the one or more expected measurement values may comprise at least one of the following: a timing of a downlink signal; a received power of a downlink signal; a round trip time between the terminal device and a reference point; a one way delay between the terminal device and a reference point; a start timing of the predicted coverage window; an end timing of the predicted coverage window; or information of an expected cell.

In some example embodiments, the method may further comprise: determining for the terminal device an updated predicted coverage window in at least one case of the following: detecting that the terminal device performs a tracking area update; or receiving from the terminal device, an inaccuracy indication indicating that the predicted coverage window is inaccurate.

In some example embodiments, the inaccuracy indication may comprise at least one of the following: a flag indicating that the predicted coverage window is inaccurate; a difference between a value of at least one measurement performed by the terminal device and a corresponding at least one expected measurement value in the measurement information; a value of the at least one measurement performed by the terminal device; a timing of the at least one measurement performed by the terminal device; an index corresponding to the at least one measurement performed by the terminal device; information of a serving cell of the terminal device; or current location information of the terminal device.

In a fifth aspect, disclosed is an apparatus. The apparatus as a terminal device may comprise: means for receiving from a network device, information on a predicted coverage window and measurement information relating to the predicted coverage window, the measurement information comprising one or more expected measurement values; means for performing, according to the predicted coverage window, at least one measurement according to the measurement information; and means for determining whether the predicted coverage window is accurate or inaccurate based on a value of the performed at least one measurement and the corresponding at least one expected measurement value from the one or more expected measurement values.

In some example embodiments, the apparatus may further comprise: means for transmitting to the network device, a request for the predicted coverage window, the request comprising at least one of the following: a number of at least one satellite to serve the terminal device; a number of one or more satellites to serve the terminal device before the predicted coverage window is to start; a duration to be covered by the predicted coverage window; a period after which the predicted coverage window is to start; a timing after which the predicted coverage window is to start; or a communication pattern of the terminal device.

In some example embodiments, the apparatus may further comprise: means for transmitting to the network device, positioning information of the terminal device, the positioning information comprising at least one of the following: current location information of the terminal device; information on a current serving cell of the terminal device; a mapped cell identifier of the current serving cell of the terminal device; or a travel itinerary of the terminal device.

In some example embodiments, the measurement information may further comprise at least one of the following: one or more timings for performing corresponding one or more expected measurements; one or more indexes corresponding to the one or more expected measurements; or at least one threshold for determining whether the predicted coverage window is accurate or inaccurate.

In some example embodiments, the one or more expected measurement values may comprise at least one of the following: a timing of a downlink signal; a received power of a downlink signal; a round trip time between the terminal device and a reference point; a one way delay between the terminal device and a reference point; a start timing of the predicted coverage window; an end timing of the predicted coverage window; or information of an expected cell, and the predicted coverage window may be determined to be inaccurate in at least one case of the following: where a difference between the value of the performed at least one measurement and the corresponding at least one expected measurement value exceeds a corresponding threshold; or where information of a serving cell from the performed at least one measurement is different from the information of the expected cell.

In some example embodiments, the apparatus may further comprise: means for transmitting to the network device, an inaccuracy indication indicating that the predicted coverage window is inaccurate, in a case where the predicted coverage window is determined to be inaccurate.

In some example embodiments, the inaccuracy indication may comprise at least one of the following: a flag indicating that the predicted coverage window is inaccurate; the difference between the value of the performed at least one measurement and the corresponding at least one expected measurement value; the value of the performed at least one measurement; the timing of the performed at least one measurement; the index corresponding to the performed at least one measurement; the information of the serving cell of the terminal device; or current location information of the terminal device.

In some example embodiments, the inaccuracy indication may be transmitted via an early data transmission procedure or a small data transmission procedure.

In some example embodiments, the apparatus may further comprise: means for remaining in a radio resource control idle state or a radio resource control inactive state in a case where the predicted coverage window is determined to be accurate.

In some example embodiments, the apparatus may further comprise: means for transmitting to the network device, another request for an updated predicted coverage window in at least one case of the following: observing a change of a location of the terminal device; or determining the predicted coverage window to be inaccurate.

In a sixth aspect, disclosed is an apparatus. The apparatus as a network device may comprise: means for determining for a terminal device a predicted coverage window and measurement information relating to the predicted coverage window; and means for transmitting to the terminal device, information on the predicted coverage window and the measurement information relating to the predicted coverage window, the measurement information comprising one or more expected measurement values for the terminal device to determine whether the predicted coverage window is accurate or inaccurate.

In some example embodiments, the apparatus may further comprise: means for receiving from the terminal device, a request for the predicted coverage window, the request comprising at least one of the following: a number of at least one satellite to serve the terminal device; a number of one or more satellites to serve the terminal device before the predicted coverage window is to start; a duration to be covered by the predicted coverage window; a period after which the predicted coverage window is to start; a timing after which the predicted coverage window is to start; or a communication pattern of the terminal device.

In some example embodiments, the predicted coverage window may be determined based on at least one of the following: satellite movement information; satellite coverage information; current location information on the terminal device; information on a current serving cell of the terminal device; a mapped cell identifier of the current serving cell of the terminal device; a travel itinerary of the terminal device; or information on a communication pattern of the terminal device.

In some example embodiments, the measurement information may further comprise at least one of the following: one or more timings for performing corresponding one or more expected measurements; one or more indexes corresponding to the one or more expected measurements; or at least one threshold for determining whether the predicted coverage window is accurate or inaccurate.

In some example embodiments, the one or more expected measurement values may comprise at least one of the following: a timing of a downlink signal; a received power of a downlink signal; a round trip time between the terminal device and a reference point; a one way delay between the terminal device and a reference point; a start timing of the predicted coverage window; an end timing of the predicted coverage window; or information of an expected cell.

In some example embodiments, the apparatus may further comprise: means for determining for the terminal device an updated predicted coverage window in at least one case of the following: detecting that the terminal device performs a tracking area update; or receiving from the terminal device, an inaccuracy indication indicating that the predicted coverage window is inaccurate.

In some example embodiments, the inaccuracy indication may comprise at least one of the following: a flag indicating that the predicted coverage window is inaccurate; a difference between a value of at least one measurement performed by the terminal device and a corresponding at least one expected measurement value in the measurement information; a value of the at least one measurement performed by the terminal device; a timing of the at least one measurement performed by the terminal device; an index corresponding to the at least one measurement performed by the terminal device; information of a serving cell of the terminal device; or current location information of the terminal device.

In a seventh aspect, a computer readable medium is disclosed. The computer readable medium may comprise program instructions that, when executed by a terminal device, may cause the terminal device at least to perform: receiving from a network device, information on a predicted coverage window and measurement information relating to the predicted coverage window, the measurement information comprising one or more expected measurement values; performing, according to the predicted coverage window, at least one measurement according to the measurement information; and determining whether the predicted coverage window is accurate or inaccurate based on a value of the performed at least one measurement and the corresponding at least one expected measurement value from the one or more expected measurement values.

In some example embodiments, the computer readable medium may further comprise instructions that, when executed by the terminal device, may cause the terminal device to further perform: transmitting to the network device, a request for the predicted coverage window, the request comprising at least one of the following: a number of at least one satellite to serve the terminal device; a number of one or more satellites to serve the terminal device before the predicted coverage window is to start; a duration to be covered by the predicted coverage window; a period after which the predicted coverage window is to start; a timing after which the predicted coverage window is to start; or a communication pattern of the terminal device.

In some example embodiments, the computer readable medium may further comprise instructions that, when executed by the terminal device, may cause the terminal device to further perform: transmitting to the network device, positioning information of the terminal device, the positioning information comprising at least one of the following: current location information of the terminal device; information on a current serving cell of the terminal device; a mapped cell identifier of the current serving cell of the terminal device; or a travel itinerary of the terminal device.

In some example embodiments, the measurement information may further comprise at least one of the following: one or more timings for performing corresponding one or more expected measurements; one or more indexes corresponding to the one or more expected measurements; or at least one threshold for determining whether the predicted coverage window is accurate or inaccurate.

In some example embodiments, the one or more expected measurement values may comprise at least one of the following: a timing of a downlink signal; a received power of a downlink signal; a round trip time between the terminal device and a reference point; a one way delay between the terminal device and a reference point; a start timing of the predicted coverage window; an end timing of the predicted coverage window; or information of an expected cell, and the predicted coverage window may be determined to be inaccurate in at least one case of the following: where a difference between the value of the performed at least one measurement and the corresponding at least one expected measurement value exceeds a corresponding threshold; or where information of a serving cell from the performed at least one measurement is different from the information of the expected cell.

In some example embodiments, the computer readable medium may further comprise instructions that, when executed by the terminal device, may cause the terminal device to further perform: transmitting to the network device, an inaccuracy indication indicating that the predicted coverage window is inaccurate, in a case where the predicted coverage window is determined to be inaccurate.

In some example embodiments, the inaccuracy indication may comprise at least one of the following: a flag indicating that the predicted coverage window is inaccurate; the difference between the value of the performed at least one measurement and the corresponding at least one expected measurement value; the value of the performed at least one measurement; the timing of the performed at least one measurement; the index corresponding to the performed at least one measurement; the information of the serving cell of the terminal device; or current location information of the terminal device.

In some example embodiments, the inaccuracy indication may be transmitted via an early data transmission procedure or a small data transmission procedure.

In some example embodiments, the computer readable medium may further comprise instructions that, when executed by the terminal device, may cause the terminal device to further perform: remaining in a radio resource control idle state or a radio resource control inactive state in a case where the predicted coverage window is determined to be accurate.

In some example embodiments, the computer readable medium may further comprise instructions that, when executed by the terminal device, may cause the terminal device to further perform: transmitting to the network device, another request for an updated predicted coverage window in at least one case of the following: observing a change of a location of the terminal device; or determining the predicted coverage window to be inaccurate.

In an eighth aspect, a computer readable medium is disclosed. The computer readable medium may comprise program instructions that, when executed by a network device, cause the network device at least to perform: determining for a terminal device a predicted coverage window and measurement information relating to the predicted coverage window; and transmitting to the terminal device, information on the predicted coverage window and the measurement information relating to the predicted coverage window, the measurement information comprising one or more expected measurement values for the terminal device to determine whether the predicted coverage window is accurate or inaccurate.

In some example embodiments, the computer readable medium may further comprise instructions that, when executed by the network device, may cause the network device to further perform: receiving from the terminal device, a request for the predicted coverage window, the request comprising at least one of the following: a number of at least one satellite to serve the terminal device; a number of one or more satellites to serve the terminal device before the predicted coverage window is to start; a duration to be covered by the predicted coverage window; a period after which the predicted coverage window is to start; a timing after which the predicted coverage window is to start; or a communication pattern of the terminal device.

In some example embodiments, the predicted coverage window may be determined based on at least one of the following: satellite movement information; satellite coverage information; current location information on the terminal device; information on a current serving cell of the terminal device; a mapped cell identifier of the current serving cell of the terminal device; a travel itinerary of the terminal device; or information on a communication pattern of the terminal device.

In some example embodiments, the measurement information may further comprise at least one of the following: one or more timings for performing corresponding one or more expected measurements; one or more indexes corresponding to the one or more expected measurements; or at least one threshold for determining whether the predicted coverage window is accurate or inaccurate.

In some example embodiments, the one or more expected measurement values may comprise at least one of the following: a timing of a downlink signal; a received power of a downlink signal; a round trip time between the terminal device and a reference point; a one way delay between the terminal device and a reference point; a start timing of the predicted coverage window; an end timing of the predicted coverage window; or information of an expected cell.

In some example embodiments, the computer readable medium may further comprise instructions that, when executed by the network device, may cause the network device to further perform: determining for the terminal device an updated predicted coverage window in at least one case of the following: detecting that the terminal device performs a tracking area update; or receiving from the terminal device, an inaccuracy indication indicating that the predicted coverage window is inaccurate.

In some example embodiments, the inaccuracy indication may comprise at least one of the following: a flag indicating that the predicted coverage window is inaccurate; a difference between a value of at least one measurement performed by the terminal device and a corresponding at least one expected measurement value in the measurement information; a value of the at least one measurement performed by the terminal device; a timing of the at least one measurement performed by the terminal device; an index corresponding to the at least one measurement performed by the terminal device; information of a serving cell of the terminal device; or current location information of the terminal device.

Other features and advantages of the example embodiments of the present disclosure will also be apparent from the following description of specific embodiments when read in conjunction with the accompanying drawings, which illustrate, by way of example, the principles of example embodiments of the present disclosure.

### BRIEF DESCRIPTION OF THE DRAWINGS

Some example embodiments will now be described, by way of non-limiting examples, with reference to the accompanying drawings.

FIG. 1 shows an exemplary sequence diagram for coverage window prediction according to the example embodiments of the present disclosure.

FIG. 2 shows an exemplary flow for coverage window prediction from perspective of a UE according to the example embodiments of the present disclosure.

FIG. 3 shows a flow chart illustrating an example method 300 for coverage window prediction according to the example embodiments of the present disclosure.

FIG. 4 shows a flow chart illustrating an example method 400 for coverage window prediction according to the example embodiments of the present disclosure.

FIG. 5 shows a block diagram illustrating an example device 500 for coverage window prediction according to the example embodiments of the present disclosure.

FIG. 6 shows a block diagram illustrating an example device 600 for coverage window prediction according to the example embodiments of the present disclosure.

FIG. 7 shows a block diagram illustrating an example apparatus 700 for coverage window prediction according to the example embodiments of the present disclosure.

FIG. 8 shows a block diagram illustrating an example apparatus 800 for coverage window prediction according to the example embodiments of the present disclosure.

Throughout the drawings, same or similar reference numbers indicate same or similar elements. A repetitive description on the same elements would be omitted.

### DETAILED DESCRIPTION

Herein below, some example embodiments are described in detail with reference to the accompanying drawings. The following description includes specific details for the purpose of providing a thorough understanding of various concepts. However, it will be apparent to those skilled in the art that these concepts may be practiced without these specific details. In some instances, well known circuits, techniques and components are shown in block diagram form to avoid obscuring the described concepts and features.

Example embodiments of the present disclosure provide a solution for providing the common understanding of the coverage window between the UE side and the network side in the NTN. According to the example embodiments of the present disclosure, the network may perform the coverage window prediction and share the predicted coverage window with the UE. Furthermore, if the coverage window predicted by the network is inaccurate, example embodiments of the present disclosure provide a mechanism to handle this scenario.

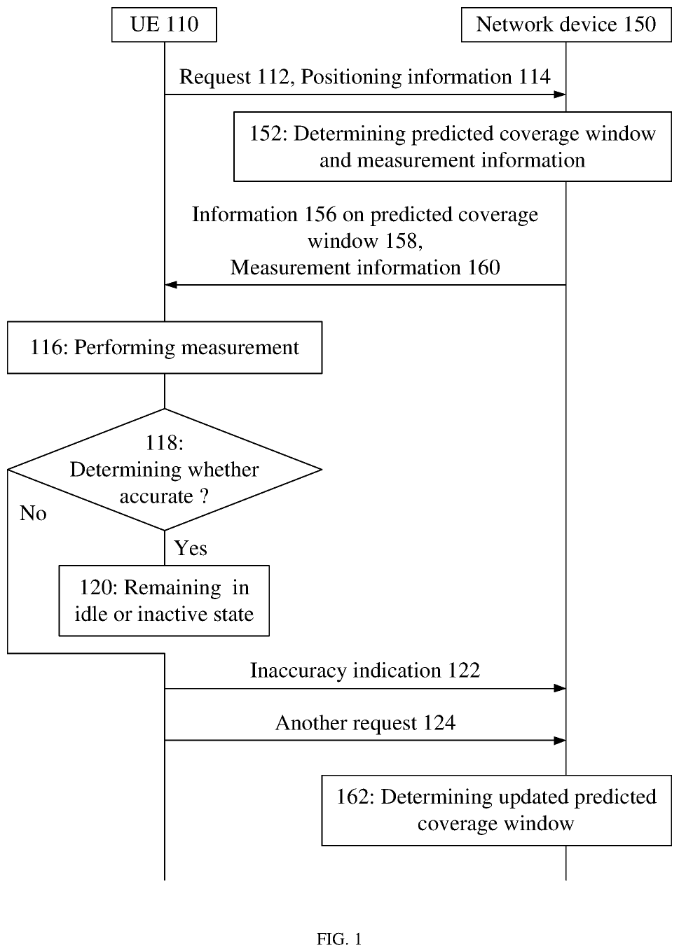

FIG. 1 shows an exemplary sequence diagram for coverage window prediction according to the example embodiments of the present disclosure. Referring to the FIG. 1, a UE 110 may represent any terminal device, for example, a NB-IoT device or an eMTC device. A network device 150 may represent a mobility management function in the NTN, for example, an access and mobility function (AMF) and/or a mobility management entity (MME), or alike in the CN.

Either the UE 110 or the network device 150 may initiate the procedure of the coverage window prediction for the UE 110. As an option, referring to the FIG. 1, the UE 110 may transmit to the network device 150, a request 112 for a predicted coverage window. In response to the request 112, in an operation 152 the network device 150 may determine a predicted coverage window 158 for the UE 110 and measurement information 160 relating to the predicted coverage window 158.

In an embodiment, the request 112 may comprise at least one of the following: a number of at least one satellite to serve the UE 110; a number of one or more satellites to serve the UE 110 before the predicted coverage window is to start; a duration to be covered by the predicted coverage window; a period after which the predicted coverage window is to start; a timing after which the predicted coverage window is to start; or a communication pattern of the UE 110.

The number of the at least one satellite to serve the UE 110 may indicate that the UE 110 suggests the next certain number, e.g. M, satellites to be covered by the predicted coverage window 158. For example, assuming that the SIB32 provides information of 4 satellites, if the UE 110 suggests the predicted coverage window 158 may cover the period to receive the next 2 SIB32, the M may be 8.

The number of one or more satellites to serve the UE 110 before the predicted coverage window is to start may indicate that the UE 110 suggests the predicted coverage window 158 may cover the period after the next certain number, e.g. N, satellites. For example, assuming that the SIB32 provides information of 4 satellites, if the UE 110 needs to be paged after the period to receive the next 3 SIB32, the N may be 12.

Alternatively, the request 112 may indicate that the UE 110 suggests a certain number, e.g. M, satellites after a certain number, e.g. N, satellites to be covered by the predicted coverage window 158. For example, if the UE 110 suggests the predicted coverage window 158 may cover 4 satellites after the next 8 satellites, the M may be 4, and the N may be 8.

The duration to be covered by the predicted coverage window may indicate that the UE 110 suggests the next certain duration, e.g. P hours, to be covered by the predicted coverage window 158. For example, if the UE 110 suggests the predicted coverage window 158 may cover the next 4 hours, the duration P may be 4.

The period after which the predicted coverage window is to start may indicate that the UE 110 suggests the predicted coverage window 158 may cover the period after the next certain period, e.g. Q hours. For example, if the UE 110 needs to be paged after 12 hours, the period Q may be 12.

The timing after which the predicted coverage window is to start may indicate that the UE 110 suggests the predicted coverage window 158 may cover the period after a certain timing, e.g. 9:30 universal time coordinated (UTC). For example, if the UE 110 needs to be paged after 9:30, the timing may be 9:30 UTC.

Alternatively, the request 112 may indicate that the UE 110 suggests a duration starting after a period to be covered by the predicted coverage window 158. For example, if the UE 110 suggests the predicted coverage window 158 may cover a future duration of 4 hours starting after 8 hours, the duration P may be 4, and the period Q may be 8.

Alternatively, the request 112 may indicate that the UE 110 suggests a duration starting from a timing to be covered by the predicted coverage window 158. For example, if the UE 110 suggests the predicted coverage window 158 may cover a future duration of 4 hours starting from a timing of 9:30, the duration P may be 4, and the timing may be 9:30.

Alternatively, the request 112 may indicate a communication pattern of the UE 110 which suggests a timing and/or a duration that the UE 110 requests for coverage. For example, if the UE 110 suggests a communication pattern that the UE will transmit/receive between 15:00-16:00, the predicted coverage window 158 may only need to cover 15:00-16:00. It is to be understood that the above alternative may be combined to indicate a future coverage window.

Receiving the request 112, in the operation 152, the network device 150 may take the request 112 into account in determining the predicted coverage window 158 for the UE 110. Alternatively, in an embodiment the network device 150 may perform the operation 152 without the request 112 and/or not considering the request 112.

In an embodiment, in the operation 152, the network device 150 may determine the predicted coverage window 158 and/or the measurement information 160 based on positioning information 114 of the UE 110. In an embodiment, the UE 110 may transmit to the network device 150, its positioning information 114.

In an embodiment, the positioning information 114 may comprise current positioning information of the UE 110 such as current location information of the UE 110, information on a current serving cell of the UE 110, and/or a mapped cell identifier (ID) of the current serving cell of the UE 110. The current location information may be, for example, the relatively precise location of the UE 110, such as relatively precise longitude, latitude, etc. Information on the current serving cell of the UE 110 may be, for example, the ID of the current serving cell (e.g. the ID of the satellite Uu cell), from which the network device 150 may obtain the approximate location of the UE 110. From the mapped cell ID of the current serving cell of the UE 110, the network device 150 may obtain the rough location of the UE 110 which may be more imprecise than the approximate location obtained from the current serving cell ID when the geographical arca corresponding to the mapped cell ID is larger than a satellite beam coverage (or a satellite Uu cell). In another example where the geographical area corresponding to the mapped cell ID is smaller than a satellite beam coverage (or a satellite Uu cell), the network device 150 may obtain the better location of the UE 110 which may be more precise than the approximate location obtained from the current serving cell ID.

Alternatively or additionally, the positioning information 114 may comprise a travel itinerary of the UE 110, which may be the future positioning information of the UE 110. For example, the travel itinerary may include the future locations of the UE 110 and the corresponding timings the UE 110 will be at the future locations, and the travel itinerary may be in a form of matrix or table, or something alike.

The above described positioning information 114 may be provided by the UE 110, alternatively or additionally, in an embodiment, the network device 150 may perform the positioning for the UE 110 and obtain the positioning information 114 by itself. Alternatively or additionally, in an embodiment, the network device 150 may obtain the positioning information 114 from other network function in the NTN, for example, a location management function (LMF)

Alternatively or additionally, in an embodiment, in the operation 152, the network device 150 may determine the predicted coverage window 158 and/or the measurement information 160 based on satellite movement information and/or satellite coverage information.

Alternatively or additionally, in an embodiment, in the operation 152, the network device 150 may determine the predicted coverage window 158 and/or the measurement information 160 based on information on a communication pattern of the UE 110. The information on the communication pattern may be, for example, the behavior of the UE 110 observed by the network device 150. Alternatively or additionally, The information on the communication pattern may be, for example, pre-provisioned expected UE behavior parameters of the UE 110, which may be e.g. the expected UE behavior parameters described in the 3rd Generation Partnership Project (3GPP) technical specification (TS) 23.502, including the parameters such as periodic time, scheduled communication time, etc.

After the operation 152, the network device 150 may transmit to the UE 110, information 156 on the predicted coverage window 158 and the measurement information 160 relating to the predicted coverage window 158. The information 156 may comprise for example the duration to be covered by the predicted coverage window 158, the starting period after which the predicted coverage window 158 is to start, the satellite(s) to serve the UE 110 to be covered by the predicted coverage window 158, and/or the satellite(s) to serve the UE 110 before the predicted coverage window 158 is to start, etc. The predicted coverage window 158 is described as an example, and the network device 150 may determine a plurality of discontinuous predicted coverage windows for the UE 110 and transmit the information of the plurality of discontinuous predicted coverage windows and corresponding measurement information to the UE 110. In this case, the predicted coverage window 158 may represent any of the plurality of discontinuous predicted coverage windows.

The measurement information 160 may comprise one or more expected measurement values for the terminal device to determine whether the predicted coverage window 158 is accurate or inaccurate. Receiving from the network device 150, information 156 on the predicted coverage window 158 and the measurement information 160 relating to the predicted coverage window 158, in an operation 116, the UE 110 may perform, according to the predicted coverage window 158, at least one measurement according to the measurement information 160. It is to be noted that the physical entity of the network device 150 at the time of the UE 110 performing the at least one measurement may perhaps be different from the physical entity of the network device 150 at the time of the UE 110 receiving the information 156 on the predicted coverage window 158 and the measurement information 160 because the UE 110 and/or the physical entities associated with the network device 150 may be moving. The network device 150 may be understood as a logical network device which is serving the UE 110 for the coverage window prediction. The at least one measurement may be performed slightly before, slightly after or during the predicted coverage window 158.

In an embodiment, the measurement information 160 may further comprise at least one of the following: one or more timings for performing corresponding one or more expected measurements; one or more indexes corresponding to the one or more expected measurements; or at least one threshold for determining whether the predicted coverage window 158 is accurate or inaccurate.

The one or more expected measurement values may involve different types of measurements In an embodiment, the one or more expected measurement values may comprise at least one of the following: a timing of a downlink signal; a received power of a downlink signal (or a signal strength of a downlink signal); a round trip time (RTT) between the UE 110 and a reference point; a one way delay between the UE 110 and a reference point; a start timing of the predicted coverage window 158; an end timing of the predicted coverage window 158; or information of an expected cell. The reference point may be an expected satellite, a base station (BS), or a point defined in a 3GPP specification.

Assuming that the predicted coverage window 158 is a future duration from 10:00 a.m. to 10:10 a.m., the measurement information 160 may include, for example, 10:02 to perform the RTT measurement and the corresponding expected measurement value, 10:04 to perform the received power of the downlink signal measurement and corresponding expected measurement value, 10:06 to perform a coverage window estimation, the corresponding expected measurement value is the start timing 10:00 and end timing 10:10 of the predicted coverage window 158, etc. The UE 110 may perform a coverage window estimation based on satellite assistance information including e.g. ephemeris, start time of an earth fixed cell, etc. and/or coverage information from e.g. SIB31 and/or SIB32.

The at least one threshold may be used to compare with the difference between the value of the actually performed at least one measurement and the corresponding expected measurement value. Alternatively or additionally, the at least one threshold or some of the at least one threshold may be determined by the UE 110. The information of the expected cell, may be, e.g. the cell ID of the satellite at 10:08 will be 1001.

The one or more expected measurements in the measurement information 160 may further corresponding one or more indexes. For example, the expected measurement at 10:02 has an index 1, and the expected measurement at 10:04 has an index 2, etc.

Then, in an operation 118, the UE 110 may determine whether the predicted coverage window 158 is accurate or inaccurate based on a value of the performed at least one measurement and the corresponding at least one expected measurement value from the one or more expected measurement values. As an option, the UE 110 may refrain from performing some expected measurement in the measurement information 160. For example, the RTT measurement at 10:02 and/or the measurement for the information of the serving cell at 10:08 may be omitted.

In the operation 118, the UE 110 may determine the predicted coverage window 158 to be inaccurate in at least one case of the following: where a difference between the value of the performed at least one measurement and the corresponding at least one expected measurement value exceeds a corresponding threshold; or where the information of the serving cell from the performed at least one measurement is different from the information of the expected cell.

For example, in a case where the expected end timing of the predicted coverage window 158 is 10:10, and the end timing of the coverage window from the actually performed measurement is 10:09, if the corresponding threshold is 20 s, the UE 110 may determine the predicted coverage window 158 to be inaccurate. The threshold of 20 s may be either from the measurement information 160, determined by the UE 110, or a fixed value defined in a 3GPP specification, etc.

Alternatively or additionally, for example, if the ID of the serving cell at 10:08 from the actually performed measurement is 1002, different from the cell ID 1001 expected at 10:08, the UE 110 may determine the predicted coverage window 158 to be inaccurate.

In a case where in the operation 118 the UE 110 determines the predicted coverage window 158 to be accurate (“Yes” prong of the operation 118), in an operation 120, the UE 110 may remain in a radio resource control (RRC) idle state or a RRC inactive state. The UE 110 may remain in the RRC idle or inactive state until the UE 110 needs to communicate with the network side and/or needs an updated coverage window prediction. As an option, the UE 110 may notify the network device 150 that the predicted coverage window 158 is accurate.

In a case where in the operation 118 the UE 110 determines the predicted coverage window 158 to be inaccurate (“No” prong of the operation 118), the UE 110 may transmit to the network device 150, an inaccuracy indication 122 indicating that the predicted coverage window 158 is inaccurate. It is to be noted that he network device 150 may be understood as a logical network device which is serving the UE 110 for the coverage window prediction. The physical entity of the network device 150 at the time of receiving the inaccuracy indication 122 may perhaps be different from the physical entity of the network device 150 at the time of transmitting the information 156 on the predicted coverage window 158 and the measurement information 160 because the UE 110 and/or the physical entities associated with the network device 150 may be moving.

In an embodiment, the inaccuracy indication 122 may comprise at least one of the following: a flag indicating that the predicted coverage window is inaccurate; the difference between the value of the performed at least one measurement and the corresponding at least one expected measurement value; the value of the performed at least one measurement; the timing of the performed at least one measurement; the index corresponding to the performed at least one measurement; the information of the serving cell of the UE 110; or current location information of the UE 110. In a case where the inaccuracy indication 122 includes the index of the performed measurement, e.g. the index 2, the corresponding timing of the performed measurement, e.g. 10:04 may be omitted from the inaccuracy indication 122, and vice versa. Alternatively or additionally, in a case where the inaccuracy indication 122 includes the value of the performed at least one measurement, the difference from the corresponding expected measurement value may be omitted from the inaccuracy indication 122, and vice versa. Alternatively or additionally, if the UE 110 has not moved since receiving the information 160 on the predicted coverage window 158, the current location information of the UE 110 may be omitted from the inaccuracy indication 122. Alternatively or additionally, if the serving cell is the expected cell, the information of the serving cell of the UE 110 may be omitted from the inaccuracy indication 122. Alternatively, the inaccuracy indication 122 may simply comprise a flag indicating that the predicted coverage window 158 is inaccurate.

In an embodiment, the UE 110 may transmit the inaccuracy indication 122 via an early data transmission (EDT) procedure or a small data transmission (SDT) procedure, or something alike, such that the UE 110 can be released to the RRC idle state after transmitting the inaccuracy indication 122.

In an embodiment, the UE 110 may transmit to the network device 150, another request 124 for an updated predicted coverage window in case of observing a change of the location of the UE 110. For example, if the UE 110 observes that its location has changed, the UE 110 may request the updated predicted coverage window from the network device 150 and refrain from determining whether the predicted coverage window 158 is accurate or inaccurate. As an option the UE 110 may provide its latest location for the network device 150 to improve the coverage window prediction accuracy. In response to the another request 124, in an operation 162, the network device 150 may determine for the UE 110 the updated predicted coverage window.

Alternatively or additionally, the UE 110 may transmit to the network device 150, the another request 124 for the updated predicted coverage window in case of determining the predicted coverage window 158 to be inaccurate in the operation 118.

Alternatively or additionally, the network device 150 may in the operation 162 determine the updated predicted coverage window for the UE 110 if detecting that the UE 110 performs a tracking area update (TAU) and/or receiving the inaccuracy indication 122. For example, if the inaccuracy indication 122 indicates that the UE 110 accesses to an unexpected cell, the network device 150 may in the operation 162 perform the updated coverage window prediction.

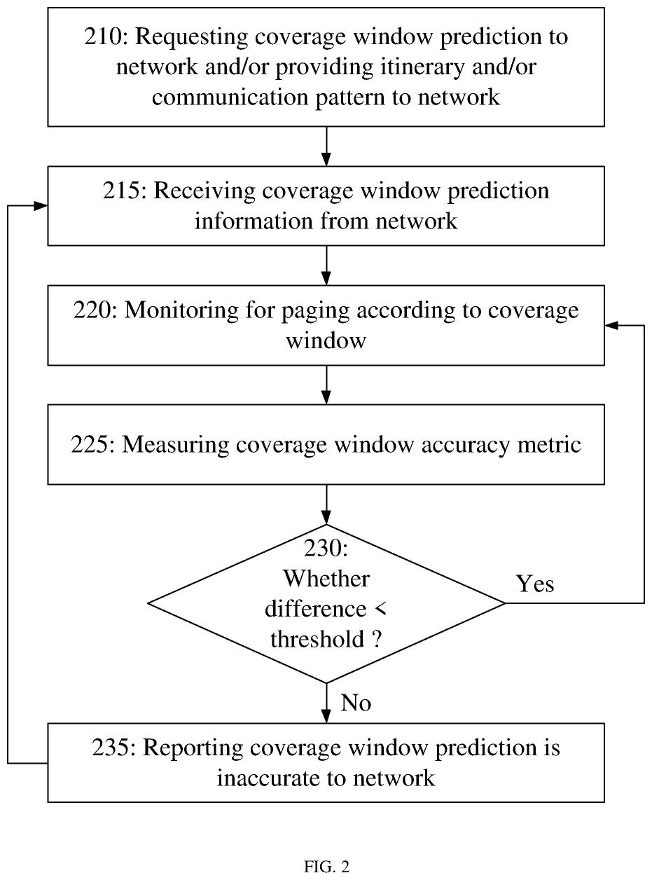

FIG. 2 shows an exemplary flow for coverage window prediction from perspective of a UE according to the example embodiments of the present disclosure. The UE 110 may represent the UE and the network device 150 may function as the network according to the exemplary flow. Details which have been described with respect to the FIG. 1 are briefly described or omitted.

In an operation 210, optionally, the UE 110 may request the network device 150 to perform a coverage window prediction. Alternatively or additionally, as an option, the UE 110 may provide its travel itinerary and/or the communication pattern to the network device 150 if the UE 110 is aware of its travel itinerary and/or the communication pattern.

In an operation 215, the UE 110 may receive coverage window prediction information from the network device 150, which may comprise for example information on a predicted coverage window and measurement information relating to the predicted coverage window.

Then, in an operation 220, according to the predicted coverage window, e.g. slightly before, slightly after or during the predicted coverage window, the UE 110 may monitor for paging, and in an operation 225, the UE 110 may measure coverage window accuracy metric, which may be the at least one measurement as indicated by the measurement information received in the operation 215.

For example, the predicted coverage window is from 10:00 to 12:00, and the measurement information includes coverage window accuracy metric with respect to a timing of a downlink signal. For example, the network device 150 may predict a propagation delay of the downlink signal towards the UE 110 at future timing T is X μs. For example, the expected measurement values may be at timing T1, e.g. 10:00, the propagation delay of the downlink signal is expected to be 3000 μs, at timing T2, e.g. 11:00, the propagation delay of the downlink signal is expected to be 3050 μs, and at timing T3, e.g. 12:00, the propagation delay of the downlink signal is expected to be 3200 μs.

The downlink signal may be, for example, synchronization signal block (SSB), which would be primary synchronization signal (PSS) and/or secondary synchronization signal (SSS) for IoT, SIB with UTC, master information block (MIB) carrying a system frame number (SFN) or a dedicated time reference signal, or something alike. The UE 110 may measure the propagation delay of the downlink signal. The propagation delay=reception timing−transmission timing. Taking the SSB as an example of the downlink signal, the UE 110 may get the transmission timing based on the SFN of the SSB and get the reception timing based on global navigation satellite system (GNSS) and/or another reference clock, e.g. the clock of a modem. Thus, at timing T the UE 110 can measure the actual propagation delay Y μs of the downlink signal and obtain a timing difference at the timing T by calculating the difference between the value Y μs of the performed measurement and the corresponding expected measurement value X μs.

Then, in an operation 230, the UE 110 may determine whether the predicted coverage window is accurate or inaccurate by compare the difference between the value of the performed measurement and the corresponding expected measurement value with a corresponding threshold, and the predicted coverage window may be determined to be inaccurate if the difference exceeds the threshold, which may be at least part of the operation 118.

For example, the UE 110 may compare the difference between the value Y μs of the performed measurement and the corresponding expected measurement value X μs with a corresponding threshold, and the predicted coverage window may be determined to be inaccurate if the difference exceeds the threshold, which may be at least part of the operation 118.

The case that the difference between the value of the performed at least one measurement and the corresponding at least one expected measurement value exceeds a corresponding threshold may include at least one of the following scenarios.

A scenario may be, for example, comparing the timing difference between Y μs at the timing T1 and X μs at the timing T1 with a corresponding threshold, comparing the timing difference between Y μs at the timing T2 and X μs at the timing T2 with a corresponding threshold, and comparing the timing difference between Y μs at the timing T3 and X μs at the timing T3 with a corresponding threshold, and if any of the timing differences exceeds the corresponding threshold, the predicted coverage window may be regarded as inaccurate.

A scenario may be, for example, comparing a sum of the timing difference between Y μs at the timing T1 and X μs at the timing T1, the timing difference between Y μs at the timing T2 and X μs at the timing T2, and the timing difference between Y μs at the timing T3 and X μs at the timing T3, with a corresponding threshold, and if the sum of the timing differences exceeds the corresponding threshold, the predicted coverage window may be regarded as inaccurate.

A scenario may be, for example, comparing an average of the timing difference between Y μs at the timing T1 and X μs at the timing T1, the timing difference between Y μs at the timing T2 and X μs at the timing T2, and the timing difference between Y μs at the timing T3 and X μs at the timing T3, with a corresponding threshold, and if the average of the timing differences exceeds the corresponding threshold, the predicted coverage window may be regarded as inaccurate.

It may be appreciated that the comparison of the difference between the value of the performed at least one measurement and the corresponding at least one expected measurement value and a corresponding threshold may be performed in other forms. For example, the expected measurement value may be expected received power at a specific timing and the UE 110 may compare the difference between the value of the performed at least one measurement of received power at the specific timing with a corresponding threshold.

If the coverage window accuracy metric does not exceed the threshold (“Yes” prong of the operation 230), which means the predicted coverage window is accurate, the UE 110 may perform the operation 220 to the monitor for paging according to the predicted coverage window.

If the coverage window accuracy metric exceeds the threshold (“No” prong of the operation 230), which means the predicted coverage window is inaccurate, in an operation 235 the UE 110 may report to the network device 150 that the predicted coverage window is inaccurate by, for example, transmitting the inaccuracy indication 122. Then the UE 110 may in the operation 215 receive an updated predicted coverage window.

According to the example embodiments of the present disclosure, the UE may monitor for paging during a certain satellites and/or a duration instead of having to provide coverage predictions to the network, and thus UE battery life may be improved. If the gap between the coverage windows are shorter than the communication intervals of the UE, then the UE power budget may be optimized because the UE does not need to provide a new or updated coverage window each time a new satellite is able to provide coverage. Furthermore, compared to the IoT UE, the network device at the CN can access to the ephemeris information of many satellites, better algorithm/model, and more processing capabilities to perform more accurate prediction(s) of coverage window(s). Moreover, according to the example embodiments of the present disclosure, the UE can detect the coverage window prediction error and help the network to recover the prediction accuracy, so the example embodiments of the present disclosure also provide a mechanism to handle the case of coverage window prediction error in the CN. In addition, according to the example embodiments of the present disclosure, because the UE may obtain UE-specific coverage window information, the cells may reduce the amount of information broadcasted in the SIB32.

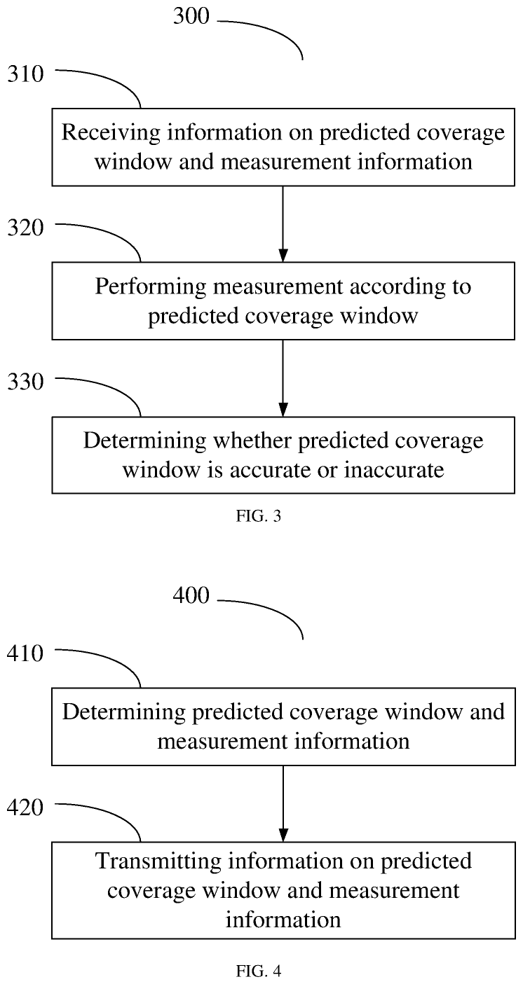

FIG. 3 shows a flow chart illustrating an example method 300 for coverage window prediction according to the example embodiments of the present disclosure. The example method 300 may be performed for example by a terminal device such as the UE 110.

Referring to the FIG. 3, the example method 300 may include an operation 310 of receiving from a network device, information on a predicted coverage window and measurement information relating to the predicted coverage window, the measurement information comprising one or more expected measurement values; an operation 320 of performing, according to the predicted coverage window, at least one measurement according to the measurement information; and an operation 330 of determining whether the predicted coverage window is accurate or inaccurate based on a value of the performed at least one measurement and the corresponding at least one expected measurement value from the one or more expected measurement values.

Details of the operation 310 have been described in the above descriptions with respect to at least the information 156, the predicted coverage window 158, the measurement information 160, and the operation 215, and repetitive descriptions thereof are omitted here.

Details of the operation 320 have been described in the above descriptions with respect to at least the operation 116, and the operation 225, and repetitive descriptions thereof are omitted here.

Details of the operation 330 have been described in the above descriptions with respect to at least the operation 118, and the operation 230, and repetitive descriptions thereof are omitted here.

In an embodiment, the example method 300 may further include an operation of transmitting to the network device, a request for the predicted coverage window, the request comprising at least one of the following: a number of at least one satellite to serve the terminal device; a number of one or more satellites to serve the terminal device before the predicted coverage window is to start; a duration to be covered by the predicted coverage window; a period after which the predicted coverage window is to start; a timing after which the predicted coverage window is to start; or a communication pattern of the terminal device. The more details have been described in the above descriptions with respect to at least the request 112, and repetitive descriptions thereof are omitted here.

In an embodiment, the example method 300 may further include an operation of transmitting to the network device, positioning information of the terminal device, the positioning information comprising at least one of the following: current location information of the terminal device; information on a current serving cell of the terminal device; a mapped cell identifier of the current serving cell of the terminal device; or a travel itinerary of the terminal device. The more details have been described in the above descriptions with respect to at least the positioning information 114, and repetitive descriptions thereof are omitted here.

In an embodiment, the measurement information may further comprise at least one of the following: one or more timings for performing corresponding one or more expected measurements; one or more indexes corresponding to the one or more expected measurements; or at least one threshold for determining whether the predicted coverage window is accurate or inaccurate. The more details have been described in the above descriptions with respect to at least the measurement information 160, and repetitive descriptions thereof are omitted here.

In an embodiment, the one or more expected measurement values may comprise at least one of the following: a timing of a downlink signal; a received power of a downlink signal; a RRT between the terminal device and a reference point; a one way delay between the terminal device and a reference point; a start timing of the predicted coverage window; an end timing of the predicted coverage window; or information of an expected cell, and the predicted coverage window may be determined to be inaccurate in at least one case of the following: where a difference between the value of the performed at least one measurement and the corresponding at least one expected measurement value exceeds a corresponding threshold; or where information of a serving cell from the performed at least one measurement is different from the information of the expected cell. The more details have been described in the above descriptions with respect to at least the measurement information 160, the operations 116 and 118, and the operations 225 and 230, and repetitive descriptions thereof are omitted here.

In an embodiment, the example method 300 may further include an operation of transmitting to the network device, an inaccuracy indication indicating that the predicted coverage window is inaccurate, in a case where the predicted coverage window is determined to be inaccurate. The more details have been described in the above descriptions with respect to at least the inaccuracy indication 122 and the operation 235, and repetitive descriptions thereof are omitted here.

In an embodiment, the inaccuracy indication may comprise at least one of the following: a flag indicating that the predicted coverage window is inaccurate; the difference between the value of the performed at least one measurement and the corresponding at least one expected measurement value; the value of the performed at least one measurement; the timing of the performed at least one measurement; the index corresponding to the performed at least one measurement; the information of the serving cell of the terminal device; or current location information of the terminal device. The more details have been described in the above descriptions with respect to at least the inaccuracy indication 122, and repetitive descriptions thereof are omitted here.

In an embodiment, the inaccuracy indication may be transmitted via an early data transmission procedure or a small data transmission procedure.

In an embodiment, the example method 300 may further include an operation of remaining in a RRC idle state or a RRC inactive state in a case where the predicted coverage window is determined to be accurate. The more details have been described in the above descriptions with respect to at least the operation 120, and repetitive descriptions thereof are omitted here.

In an embodiment, the example method 300 may further include an operation of transmitting to the network device, another request for an updated predicted coverage window in at least one case of the following: observing a change of a location of the terminal device; or determining the predicted coverage window to be inaccurate. The more details have been described in the above descriptions with respect to at least the another request 124, and repetitive descriptions thereof are omitted here.

FIG. 4 shows a flow chart illustrating an example method 400 for coverage window prediction according to the example embodiments of the present disclosure. The example method 400 may be performed for example by a network device such as the network device 150.

Referring to the FIG. 4, the example method 400 may include an operation 410 of determining for a terminal device a predicted coverage window and measurement information relating to the predicted coverage window; and an operation 420 of transmitting to the terminal device, information on the predicted coverage window and the measurement information relating to the predicted coverage window, the measurement information comprising one or more expected measurement values for the terminal device to determine whether the predicted coverage window is accurate or inaccurate.

Details of the operation 410 have been described in the above descriptions with respect to at least the operation 152, and repetitive descriptions thereof are omitted here.

Details of the operation 420 have been described in the above descriptions with respect to at least the information 156, the predicted coverage window 158, and the measurement information 160, and repetitive descriptions thereof are omitted here.

In an embodiment, the example method 400 may further include an operation of receiving from the terminal device, a request for the predicted coverage window, the request comprising at least one of the following: a number of at least one satellite to serve the terminal device; a number of one or more satellites to serve the terminal device before the predicted coverage window is to start; a duration to be covered by the predicted coverage window; a period after which the predicted coverage window is to start; a timing after which the predicted coverage window is to start; or a communication pattern of the terminal device. The more details have been described in the above descriptions with respect to at least the request 112, and repetitive descriptions thereof are omitted here.

In an embodiment, the predicted coverage window may be determined based on at least one of the following: satellite movement information; satellite coverage information; current location information on the terminal device; information on a current serving cell of the terminal device; a mapped cell identifier of the current serving cell of the terminal device; a travel itinerary of the terminal device; or information on a communication pattern of the terminal device. The more details have been described in the above descriptions with respect to at least the operation 152, and repetitive descriptions thereof are omitted here.

In an embodiment, the measurement information may further comprise at least one of the following: one or more timings for performing corresponding one or more expected measurements; one or more indexes corresponding to the one or more expected measurements; or at least one threshold for determining whether the predicted coverage window is accurate or inaccurate. The more details have been described in the above descriptions with respect to at least the measurement information 160, and repetitive descriptions thereof are omitted here.

In an embodiment, the one or more expected measurement values may comprise at least one of the following: a timing of a downlink signal; a received power of a downlink signal; a RRT between the terminal device and a reference point; a one way delay between the terminal device and a reference point; a start timing of the predicted coverage window; an end timing of the predicted coverage window; or information of an expected cell. The more details have been described in the above descriptions with respect to at least the measurement information 160, the operations 116 and 118, and the operations 225 and 230, and repetitive descriptions thereof are omitted here.

In an embodiment, the example method 400 may further include an operation of determining for the terminal device an updated predicted coverage window in at least one case of the following: detecting that the terminal device performs a tracking area update; or receiving from the terminal device, an inaccuracy indication indicating that the predicted coverage window is inaccurate. The more details have been described in the above descriptions with respect to at least the operation 162, and repetitive descriptions thereof are omitted here.

In an embodiment, the inaccuracy indication may comprises at least one of the following: a flag indicating that the predicted coverage window is inaccurate; a difference between a value of at least one measurement performed by the terminal device and a corresponding at least one expected measurement value in the measurement information; a value of the at least one measurement performed by the terminal device; a timing of the at least one measurement performed by the terminal device; an index corresponding to the at least one measurement performed by the terminal device; information of a serving cell of the terminal device; or current location information of the terminal device. The more details have been described in the above descriptions with respect to at least the inaccuracy indication 122, and repetitive descriptions thereof are omitted here.

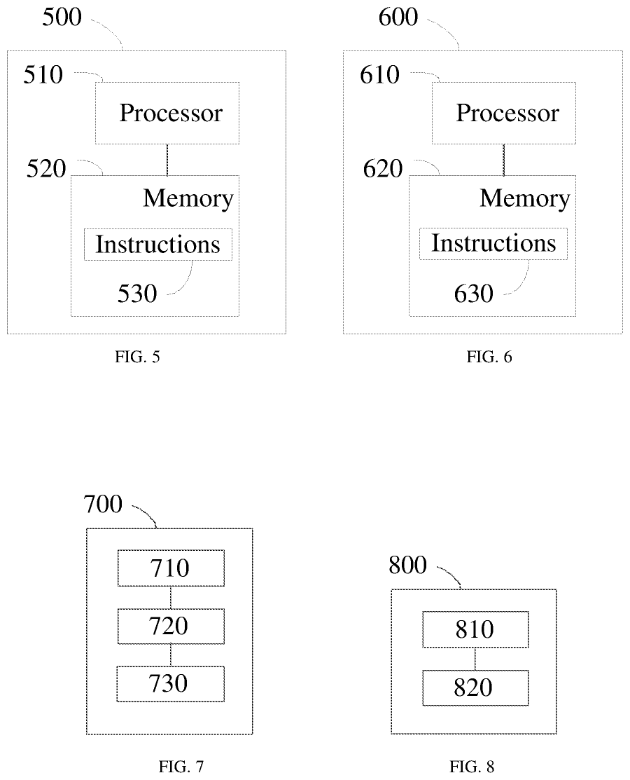

FIG. 5 shows a block diagram illustrating an example device 500 for coverage window prediction according to the example embodiments of the present disclosure. The device, for example, may be at least part of a terminal device such as the UE 110 in the above examples.

As shown in the FIG. 5, the example device 500 may include at least one processor 510 and at least one memory 520 that may store instructions 530. The instructions 530, when executed by the at least one processor 510, may cause the device 500 at least to perform the example method 300 described above.

In various example embodiments, the at least one processor 510 in the example device 500 may include, but not limited to, at least one hardware processor, including at least one microprocessor such as a central processing unit (CPU), a portion of at least one hardware processor, and any other suitable dedicated processor such as those developed based on for example Field Programmable Gate Array (FPGA) and Application Specific Integrated Circuit (ASIC). Further, the at least one processor 510 may also include at least one other circuitry or element not shown in the FIG. 5.

In various example embodiments, the at least one memory 520 in the example device 500 may include at least one storage medium in various forms, such as a transitory memory and/or a non-transitory memory. The transitory memory may include, but not limited to, for example, a random-access memory (RAM), a cache, and so on. The non-transitory memory may include, but not limited to, for example, a read only memory (ROM), a hard disk, a flash memory, and so on. The term “non-transitory,” as used herein, is a limitation of the medium itself (i.e., tangible, not a signal) as opposed to a limitation on data storage persistency (e.g., RAM vs. ROM). Further, the at least memory 520 may include, but are not limited to, an electric, a magnetic, an optical, an electromagnetic, an infrared, or a semiconductor system, apparatus, or device or any combination of the above.

Further, in various example embodiments, the example device 500 may also include at least one other circuitry, element, and interface, for example at least one I/O interface, at least one antenna element, and the like.

In various example embodiments, the circuitries, parts, elements, and interfaces in the example device 500, including the at least one processor 510 and the at least one memory 520, may be coupled together via any suitable connections including, but not limited to, buses, crossbars, wiring and/or wireless lines, in any suitable ways, for example electrically, magnetically, optically, electromagnetically, and the like.

It is appreciated that the structure of the device on the side of the UE 110 is not limited to the above example device 500.

FIG. 6 shows a block diagram illustrating an example device 600 for coverage window prediction according to the example embodiments of the present disclosure. The device, for example, may be at least part of a network device such as the network device 150 in the above examples.

As shown in the FIG. 6, the example device 600 may include at least one processor 610 and at least one memory 620 that may store instructions 630. The instructions 630, when executed by the at least one processor 610, may cause the device 600 at least to perform the example method 400 described above.

In various example embodiments, the at least one processor 610 in the example device 600 may include, but not limited to, at least one hardware processor, including at least one microprocessor such as a central processing unit (CPU), a portion of at least one hardware processor, and any other suitable dedicated processor such as those developed based on for example Field Programmable Gate Array (FPGA) and Application Specific Integrated Circuit (ASIC). Further, the at least one processor 610 may also include at least one other circuitry or element not shown in the FIG. 6.

In various example embodiments, the at least one memory 620 in the example device 600 may include at least one storage medium in various forms, such as a transitory memory and/or a non-transitory memory. The transitory memory may include, but not limited to, for example, a random-access memory (RAM), a cache, and so on. The non-transitory memory may include, but not limited to, for example, a read only memory (ROM), a hard disk, a flash memory, and so on. The term “non-transitory,” as used herein, is a limitation of the medium itself (i.e., tangible, not a signal) as opposed to a limitation on data storage persistency (e.g., RAM vs. ROM). Further, the at least memory 620 may include, but are not limited to, an electric, a magnetic, an optical, an electromagnetic, an infrared, or a semiconductor system, apparatus, or device or any combination of the above.

Further, in various example embodiments, the example device 600 may also include at least one other circuitry, element, and interface, for example at least one I/O interface, at least one antenna element, and the like.

In various example embodiments, the circuitries, parts, elements, and interfaces in the example device 600, including the at least one processor 610 and the at least one memory 620, may be coupled together via any suitable connections including, but not limited to, buses, crossbars, wiring and/or wireless lines, in any suitable ways, for example electrically, magnetically, optically, electromagnetically, and the like.

It is appreciated that the structure of the device on the side of the network device 150 is not limited to the above example device 600.

FIG. 7 shows a block diagram illustrating an example apparatus 700 for coverage window prediction according to the example embodiments of the present disclosure. The apparatus, for example, may be at least part of a terminal device such as the UE 110 in the above examples.

As shown in FIG. 7, the example apparatus 700 may include means 710 for performing the operation 310 of the example method 300, means 720 for performing the operation 320 of the example method 300, and means 730 for performing the operation 330 of the example method 300. In one or more another example embodiments, at least one I/O interface, at least one antenna element, and the like may also be included in the example apparatus 700.

In an embodiment, the example apparatus 700 may further include means for transmitting to the network device, a request for the predicted coverage window, the request comprising at least one of the following: a number of at least one satellite to serve the terminal device; a number of one or more satellites to serve the terminal device before the predicted coverage window is to start; a duration to be covered by the predicted coverage window; a period after which the predicted coverage window is to start; a timing after which the predicted coverage window is to start; or a communication pattern of the terminal device.

In an embodiment, the example apparatus 700 may further include means for transmitting to the network device, positioning information of the terminal device, the positioning information comprising at least one of the following: current location information of the terminal device; information on a current serving cell of the terminal device; a mapped cell identifier of the current serving cell of the terminal device; or a travel itinerary of the terminal device.

In an embodiment, the measurement information may further comprise at least one of the following: one or more timings for performing corresponding one or more expected measurements; one or more indexes corresponding to the one or more expected measurements; or at least one threshold for determining whether the predicted coverage window is accurate or inaccurate.

In an embodiment, the one or more expected measurement values may comprise at least one of the following: a timing of a downlink signal; a received power of a downlink signal; a RRT between the terminal device and a reference point; a one way delay between the terminal device and a reference point; a start timing of the predicted coverage window; an end timing of the predicted coverage window; or information of an expected cell, and the predicted coverage window may be determined to be inaccurate in at least one case of the following: where a difference between the value of the performed at least one measurement and the corresponding at least one expected measurement value exceeds a corresponding threshold; or where information of a serving cell from the performed at least one measurement is different from the information of the expected cell.

In an embodiment, the example apparatus 700 may further include means for transmitting to the network device, an inaccuracy indication indicating that the predicted coverage window is inaccurate, in a case where the predicted coverage window is determined to be inaccurate.

In an embodiment, the inaccuracy indication may comprise at least one of the following: a flag indicating that the predicted coverage window is inaccurate; the difference between the value of the performed at least one measurement and the corresponding at least one expected measurement value; the value of the performed at least one measurement; the timing of the performed at least one measurement; the index corresponding to the performed at least one measurement; the information of the serving cell of the terminal device; or current location information of the terminal device.

In an embodiment, the inaccuracy indication may be transmitted via an early data transmission procedure or a small data transmission procedure.

In an embodiment, the example apparatus 700 may further include means for remaining in a RRC idle state or a RRC inactive state in a case where the predicted coverage window is determined to be accurate.

In an embodiment, the example apparatus 700 may further include means for transmitting to the network device, another request for an updated predicted coverage window in at least one case of the following: observing a change of a location of the terminal device; or determining the predicted coverage window to be inaccurate.

In some example embodiments, examples of means in the example apparatus 700 may include circuitries. For example, an example of means 710 may include a circuitry configured to perform the operation 310 of the example method 300, an example of means 720 may include a circuitry configured to perform the operation 320 of the example method 300, and an example of means 730 may include a circuitry configured to perform the operation 330 of the example method 300.

The example apparatus 700 may further include means comprising circuitry configured to perform the example method 300. In some example embodiments, examples of means may also include software modules and any other suitable function entities.

FIG. 8 shows a block diagram illustrating an example apparatus 800 for coverage window prediction according to the example embodiments of the present disclosure. The apparatus, for example, may be at least part of a network device such as the network device 150 in the above examples.

As shown in FIG. 8, the example apparatus 800 may include means 810 for performing the operation 410 of the example method 400, and means 820 for performing the operation 420 of the example method 400. In one or more another example embodiments, at least one I/O interface, at least one antenna element, and the like may also be included in the example apparatus 800.

In an embodiment, the example apparatus 800 may further include means for receiving from the terminal device, a request for the predicted coverage window, the request comprising at least one of the following: a number of at least one satellite to serve the terminal device; a number of one or more satellites to serve the terminal device before the predicted coverage window is to start; a duration to be covered by the predicted coverage window; a period after which the predicted coverage window is to start; a timing after which the predicted coverage window is to start; or a communication pattern of the terminal device.

In an embodiment, the predicted coverage window may be determined based on at least one of the following: satellite movement information; satellite coverage information; current location information on the terminal device; information on a current serving cell of the terminal device; a mapped cell identifier of the current serving cell of the terminal device; a travel itinerary of the terminal device; or information on a communication pattern of the terminal device.

In an embodiment, the measurement information may further comprise at least one of the following: one or more timings for performing corresponding one or more expected measurements; one or more indexes corresponding to the one or more expected measurements; or at least one threshold for determining whether the predicted coverage window is accurate or inaccurate.

In an embodiment, the one or more expected measurement values may comprise at least one of the following: a timing of a downlink signal; a received power of a downlink signal; a RRT between the terminal device and a reference point; a one way delay between the terminal device and a reference point; a start timing of the predicted coverage window; an end timing of the predicted coverage window; or information of an expected cell.

In an embodiment, the example apparatus 800 may further include means for determining for the terminal device an updated predicted coverage window in at least one case of the following: detecting that the terminal device performs a tracking area update; or receiving from the terminal device, an inaccuracy indication indicating that the predicted coverage window is inaccurate.

In an embodiment, the inaccuracy indication may comprises at least one of the following: a flag indicating that the predicted coverage window is inaccurate; a difference between a value of at least one measurement performed by the terminal device and a corresponding at least one expected measurement value in the measurement information; a value of the at least one measurement performed by the terminal device; a timing of the at least one measurement performed by the terminal device; an index corresponding to the at least one measurement performed by the terminal device; information of a serving cell of the terminal device; or current location information of the terminal device.

In some example embodiments, examples of means in the example apparatus 800 may include circuitries. For example, an example of means 810 may include a circuitry configured to perform the operation 410 of the example method 400, and an example of means 820 may include a circuitry configured to perform the operation 420 of the example method 400.

The example apparatus 800 may further include means comprising circuitry configured to perform the example method 400. In some example embodiments, examples of means may also include software modules and any other suitable function entities.

The example embodiments of the present disclosure also provide a computer readable medium comprising program instructions that, when executed by a terminal device such as the UE 110 in the above examples, may cause the terminal device at least to perform: receiving from a network device, information on a predicted coverage window and measurement information relating to the predicted coverage window, the measurement information comprising one or more expected measurement values; performing, according to the predicted coverage window, at least one measurement according to the measurement information; and determining whether the predicted coverage window is accurate or inaccurate based on a value of the performed at least one measurement and the corresponding at least one expected measurement value from the one or more expected measurement values.

In an embodiment, the computer readable medium may further include instructions that, when executed by the terminal device, may cause the terminal device to further perform: transmitting to the network device, a request for the predicted coverage window, the request comprising at least one of the following: a number of at least one satellite to serve the terminal device; a number of one or more satellites to serve the terminal device before the predicted coverage window is to start; a duration to be covered by the predicted coverage window; a period after which the predicted coverage window is to start; a timing after which the predicted coverage window is to start; or a communication pattern of the terminal device.

In an embodiment, the computer readable medium may further include instructions that, when executed by the terminal device, may cause the terminal device to further perform: transmitting to the network device, positioning information of the terminal device, the positioning information comprising at least one of the following: current location information of the terminal device; information on a current serving cell of the terminal device; a mapped cell identifier of the current serving cell of the terminal device; or a travel itinerary of the terminal device.

In an embodiment, the measurement information may further comprise at least one of the following: one or more timings for performing corresponding one or more expected measurements; one or more indexes corresponding to the one or more expected measurements; or at least one threshold for determining whether the predicted coverage window is accurate or inaccurate.

In an embodiment, the one or more expected measurement values may comprise at least one of the following: a timing of a downlink signal; a received power of a downlink signal; a RRT between the terminal device and a reference point; a one way delay between the terminal device and a reference point; a start timing of the predicted coverage window; an end timing of the predicted coverage window; or information of an expected cell, and the predicted coverage window may be determined to be inaccurate in at least one case of the following: where a difference between the value of the performed at least one measurement and the corresponding at least one expected measurement value exceeds a corresponding threshold; or where information of a serving cell from the performed at least one measurement is different from the information of the expected cell.

In an embodiment, the computer readable medium may further include instructions that, when executed by the terminal device, may cause the terminal device to further perform: transmitting to the network device, an inaccuracy indication indicating that the predicted coverage window is inaccurate, in a case where the predicted coverage window is determined to be inaccurate.

In an embodiment, the inaccuracy indication may comprise at least one of the following: a flag indicating that the predicted coverage window is inaccurate; the difference between the value of the performed at least one measurement and the corresponding at least one expected measurement value; the value of the performed at least one measurement; the timing of the performed at least one measurement; the index corresponding to the performed at least one measurement; the information of the serving cell of the terminal device; or current location information of the terminal device.

In an embodiment, the inaccuracy indication may be transmitted via an early data transmission procedure or a small data transmission procedure.

In an embodiment, the computer readable medium may further include instructions that, when executed by the terminal device, may cause the terminal device to further perform: remaining in a RRC idle state or a RRC inactive state in a case where the predicted coverage window is determined to be accurate.

In an embodiment, the computer readable medium may further include instructions that, when executed by the terminal device, may cause the terminal device to further perform: transmitting to the network device, another request for an updated predicted coverage window in at least one case of the following: observing a change of a location of the terminal device; or determining the predicted coverage window to be inaccurate.

The example embodiments of the present disclosure also provide a computer readable medium comprising program instructions that, when executed by a network device such as the network device 150 in the above examples, may cause the network device at least to perform: determining for a terminal device a predicted coverage window and measurement information relating to the predicted coverage window; and transmitting to the terminal device, information on the predicted coverage window and the measurement information relating to the predicted coverage window, the measurement information comprising one or more expected measurement values for the terminal device to determine whether the predicted coverage window is accurate or inaccurate.

In an embodiment, the computer readable medium may further include instructions that, when executed by the network device, may cause the network device to further perform: receiving from the terminal device, a request for the predicted coverage window, the request comprising at least one of the following: a number of at least one satellite to serve the terminal device; a number of one or more satellites to serve the terminal device before the predicted coverage window is to start; a duration to be covered by the predicted coverage window; a period after which the predicted coverage window is to start; a timing after which the predicted coverage window is to start; or a communication pattern of the terminal device.

In an embodiment, the predicted coverage window may be determined based on at least one of the following: satellite movement information; satellite coverage information; current location information on the terminal device; information on a current serving cell of the terminal device; a mapped cell identifier of the current serving cell of the terminal device; a travel itinerary of the terminal device; or information on a communication pattern of the terminal device.

In an embodiment, the measurement information may further comprise at least one of the following: one or more timings for performing corresponding one or more expected measurements; one or more indexes corresponding to the one or more expected measurements; or at least one threshold for determining whether the predicted coverage window is accurate or inaccurate.

In an embodiment, the one or more expected measurement values may comprise at least one of the following: a timing of a downlink signal; a received power of a downlink signal; a RRT between the terminal device and a reference point; a one way delay between the terminal device and a reference point; a start timing of the predicted coverage window; an end timing of the predicted coverage window; or information of an expected cell.

In an embodiment, the computer readable medium may further include instructions that, when executed by the network device, may cause the network device to further perform: determining for the terminal device an updated predicted coverage window in at least one case of the following: detecting that the terminal device performs a tracking area update; or receiving from the terminal device, an inaccuracy indication indicating that the predicted coverage window is inaccurate.

In an embodiment, the inaccuracy indication may comprises at least one of the following: a flag indicating that the predicted coverage window is inaccurate; a difference between a value of at least one measurement performed by the terminal device and a corresponding at least one expected measurement value in the measurement information; a value of the at least one measurement performed by the terminal device; a timing of the at least one measurement performed by the terminal device; an index corresponding to the at least one measurement performed by the terminal device; information of a serving cell of the terminal device; or current location information of the terminal device.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VOIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. The terminal device may also correspond to a Mobile Termination (MT) part of an IAB node (e.g., a relay node). In the above description, the terms “terminal device”, “communication device”, “terminal”, “user equipment” and “UE” may be used interchangeably.

The term “circuitry” throughout this disclosure may refer to one or more or all of the following: (a) hardware-only circuit implementations (such as implementations in only analog and/or digital circuitry); (b) combinations of hardware circuits and software, such as (as applicable) (i) a combination of analog and/or digital hardware circuit(s) with software/firmware and (ii) any portions of hardware processor(s) with software (including digital signal processor(s)), software, and memory(ies) that work together to cause an apparatus, such as a mobile phone or server, to perform various functions); and (c) hardware circuit(s) and or processor(s), such as a microprocessor(s) or a portion of a microprocessor(s), that requires software (e.g., firmware) for operation, but the software may not be present when it is not needed for operation. This definition of circuitry applies to one or all uses of this term in this disclosure, including in any claims. As a further example, as used in this disclosure, the term circuitry also covers an implementation of merely a hardware circuit or processor (or multiple processors) or portion of a hardware circuit or processor and its (or their) accompanying software and/or firmware. The term circuitry also covers, for example and if applicable to the claim element, a baseband integrated circuit or processor integrated circuit for a mobile device or a similar integrated circuit in server, a cellular network device, or other computing or network device.

Another example embodiment may relate to computer program codes or instructions which may cause an apparatus to perform at least respective methods described above. Another example embodiment may be related to a computer readable medium having such computer program codes or instructions stored thereon. In some embodiments, such a computer readable medium may include at least one storage medium in various forms such as a volatile memory and/or a non-volatile memory. The volatile memory may include, but not limited to, for example, a RAM, a cache, and so on. The non-volatile memory may include, but not limited to, a ROM, a hard disk, a flash memory, and so on. The non-volatile memory may also include, but are not limited to, an electric, a magnetic, an optical, an electromagnetic, an infrared, or a semiconductor system, apparatus, or device or any combination of the above.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” The word “coupled”, as generally used herein, refers to two or more elements that may be either directly connected, or connected by way of one or more intermediate elements. Likewise, the word “connected”, as generally used herein, refers to two or more elements that may be either directly connected, or connected by way of one or more intermediate elements. Additionally, the words “herein,” “above,” “below,” and words of similar import, when used in this application, shall refer to this application as a whole and not to any particular portions of this application. Where the context permits, words in the description using the singular or plural number may also include the plural or singular number respectively. The word “or” in reference to a list of two or more items, that word covers all of the following interpretations of the word: any of the items in the list, all of the items in the list, and any combination of the items in the list.

Moreover, conditional language used herein, such as, among others, “can,” “could,” “might,” “may,” “e.g.,” “for example,” “such as” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment.

As used herein, the term “determine/determining” (and grammatical variants thereof) can include, not least: calculating, computing, processing, deriving, measuring, investigating, looking up (for example, looking up in a table, a database or another data structure), ascertaining and the like. Also, “determining” can include receiving (for example, receiving information), accessing (for example, accessing data in a memory), obtaining and the like. Also, “determine/determining” can include resolving, selecting, choosing, establishing, and the like.

While some embodiments have been described, these embodiments have been presented by way of example, and are not intended to limit the scope of the disclosure. Indeed, the apparatus, methods, and systems described herein may be embodied in a variety of other forms; furthermore, various omissions, substitutions and changes in the form of the methods and systems described herein may be made without departing from the spirit of the disclosure. For example, while blocks are presented in a given arrangement, alternative embodiments may perform similar functionalities with different components and/or circuit topologies, and some blocks may be deleted, moved, added, subdivided, combined, and/or modified. At least one of these blocks may be implemented in a variety of different ways. The order of these blocks may also be changed. Any suitable combination of the elements and actions of the some embodiments described above can be combined to provide further embodiments. The accompanying claims and their equivalents are intended to cover such forms or modifications as would fall within the scope and spirit of the disclosure.

Abbreviations used in the description and/or in the figures are defined as follows:

| | |
|---|---|
| 3GPP | 3rd Generation Partnership Project |
| AMF | access and mobility function |
| BS | base station |
| CN | core network |
| DL | downlink |
| EDT | early data transmission |
| eMTC | enhanced machine type communication |
| GNSS | global navigation satellite system |
| ID | identifier |
| IoT | internet of things |
| LMF | location management function |
| MIB | master information block |
| MME | mobility management entity |
| NB-IoT | narrowband internet of things |
| NTN | non-terrestrial network |
| PSS | primary synchronization signal |
| RRC | radio resource control |
| RTT | round trip time |
| SDT | small data transmission |
| SFN | system frame number |
| SIB | system information block |
| SSB | synchronization signal block |
| SSS | secondary synchronization signal |
| TAU | tracking area update |
| TS | technical specification |
| UE | user equipment |
| UL | uplink |
| UTC | universal time coordinated |

1. A terminal device, comprising:
at least one processor; and
at least one memory storing instructions that, when executed by the at least one processor, cause the terminal device at least to perform:
receiving from a network device, information on a predicted coverage window and measurement information relating to the predicted coverage window, the measurement information comprising one or more expected measurement values;
performing, according to the predicted coverage window, at least one measurement according to the measurement information; and
determining whether the predicted coverage window is accurate or inaccurate based on a value of the performed at least one measurement and the corresponding at least one expected measurement value from the one or more expected measurement values.

2. The terminal device of claim 1, wherein the instructions, when executed by the at least one processor, cause the terminal device to further perform:
transmitting to the network device, a request for the predicted coverage window, the request comprising at least one of the following:
a number of at least one satellite to serve the terminal device;
a number of one or more satellites to serve the terminal device before the predicted coverage window is to start;
a duration to be covered by the predicted coverage window;
a period after which the predicted coverage window is to start;
a timing after which the predicted coverage window is to start; or
a communication pattern of the terminal device.

3. The terminal device of claim 1, wherein the instructions, when executed by the at least one processor, cause the terminal device to further perform;
transmitting to the network device, positioning information of the terminal device, the positioning information comprising at least one of the following:
current location information of the terminal device;
information on a current serving cell of the terminal device;
a mapped cell identifier of the current serving cell of the terminal device; or
a travel itinerary of the terminal device.

4. The terminal device of claim 1, wherein the measurement information further comprises at least one of the following:
one or more timings for performing corresponding one or more expected measurements;
one or more indexes corresponding to the one or more expected measurements; or
at least one threshold for determining whether the predicted coverage window is accurate or inaccurate.

5. The terminal device of claim 1, wherein the one or more expected measurement values comprise at least one of the following:
a timing of a downlink signal;
a received power of a downlink signal;
a round trip time between the terminal device and a reference point;
a one way delay between the terminal device and a reference point;
a start timing of the predicted coverage window;
an end timing of the predicted coverage window; or
information of an expected cell, and
the predicted coverage window is determined to be inaccurate in at least one case of the following:
where a difference between the value of the performed at least one measurement and the corresponding at least one expected measurement value exceeds a corresponding threshold; or
where information of a serving cell from the performed at least one measurement is different from the information of the expected cell.

6. The terminal device of claim 5, wherein the instructions, when executed by the at least one processor, cause the terminal device to further perform:
transmitting to the network device, an inaccuracy indication indicating that the predicted coverage window is inaccurate, in a case where the predicted coverage window is determined to be inaccurate.

7. The terminal device of claim 5, wherein the instructions, when executed by the at least one processor, cause the terminal device to further perform:
transmitting to the network device, an inaccuracy indication indicating that the predicted coverage window is inaccurate, in a case where the predicted coverage window is determined to be inaccurate; and wherein the inaccuracy indication comprises at least one of the following:
a flag indicating that the predicted coverage window is inaccurate;
the difference between the value of the performed at least one measurement and the corresponding at least one expected measurement value:
the value of the performed at least one measurement;
the timing of the performed at least one measurement;
the index corresponding to the performed at least one measurement;
the information of the serving cell of the terminal device; or
current location information of the terminal device.

8. The terminal device of claim 5, wherein the instructions, when executed by the at least one processor, cause the terminal device to further perform:
transmitting to the network device, an inaccuracy indication indicating that the predicted coverage window is inaccurate, in a case where the predicted coverage window is determined to be inaccurate, wherein the inaccuracy indication is transmitted via an early data transmission procedure or a small data transmission procedure.

9. The terminal device of claim 1, wherein the instructions, when executed by the at least one processor, cause the terminal device to further perform:
remaining in a radio resource control idle state or a radio resource control inactive state in a case where the predicted coverage window is determined to be accurate.

10. The terminal device of claim 1, wherein the instructions, when executed by the at least one processor, cause the terminal device to further perform:
transmitting to the network device, another request for an updated predicted coverage window in at least one case of the following:
observing a change of a location of the terminal device; or
determining the predicted coverage window to be inaccurate.

11. A network device, comprising:
at least one processor; and
at least one memory storing instructions that, when executed by the at least one processor, cause the network device to perform:
determining for a terminal device a predicted coverage window and measurement information relating to the predicted coverage window; and
transmitting to the terminal device, information on the predicted coverage window and the measurement information relating to the predicted coverage window, the measurement information comprising one or more expected measurement values for the terminal device to determine whether the predicted coverage window is accurate or inaccurate.

12. The network device of claim 11, wherein the instructions, when executed by the at least one processor, cause the network device to further perform:
receiving from the terminal device, a request for the predicted coverage window, the request comprising at least one of the following:
a number of at least one satellite to serve the terminal device;
a number of one or more satellites to serve the terminal device before the predicted coverage window is to start;
a duration to be covered by the predicted coverage window;
a period after which the predicted coverage window is to start:
a timing after which the predicted coverage window is to start; or
a communication pattern of the terminal device.

13. The network device of claim 11, wherein the predicted coverage window is determined based on at least one of the following:
satellite movement information;
satellite coverage information;
current location information on the terminal device;
information on a current serving cell of the terminal device;
a mapped cell identifier of the current serving cell of the terminal device;
a travel itinerary of the terminal device; or
information on a communication pattern of the terminal device.

14. The network device of claim 11, wherein the measurement information further comprises at least one of the following:
one or more timings for performing corresponding one or more expected measurements;
one or more indexes corresponding to the one or more expected measurements; or
at least one threshold for determining whether the predicted coverage window is accurate or inaccurate.

15. The network device of claim 11, wherein the one or more expected measurement values comprise at least one of the following:
a timing of a downlink signal;
a received power of a downlink signal;
a round trip time between the terminal device and a reference point;
a one way delay between the terminal device and a reference point;
a start timing of the predicted coverage window;
an end timing of the predicted coverage window; or
information of an expected cell.

16. The network device of claim 11, wherein the instructions, when executed by the at least one processor, cause the network device to further perform:
determining for the terminal device an updated predicted coverage window in at least one case of the following:
detecting that the terminal device performs a tracking area update; or
receiving from the terminal device, an inaccuracy indication indicating that the predicted coverage window is inaccurate.

17. The network device of claim 16, wherein the inaccuracy indication comprises at least one of the following:
a flag indicating that the predicted coverage window is inaccurate;
a difference between a value of at least one measurement performed by the terminal device and a corresponding at least one expected measurement value in the measurement information;
a value of the at least one measurement performed by the terminal device;
a timing of the at least one measurement performed by the terminal device;
an index corresponding to the at least one measurement performed by the terminal device;
information of a serving cell of the terminal device; or
current location information of the terminal device.

18. A method performed by a terminal device, comprising:
receiving from a network device, information on a predicted coverage window and measurement information relating to the predicted coverage window, the measurement information comprising one or more expected measurement values;
performing, according to the predicted coverage window, at least one measurement according to the measurement information; and
determining whether the predicted coverage window is accurate or inaccurate based on a value of the performed at least one measurement and the corresponding at least one expected measurement value from the one or more expected measurement values.

19. The method of claim 18, further comprising:
transmitting to the network device, a request for the predicted coverage window, the request comprising at least one of the following:
a number of at least one satellite to serve the terminal device;
a number of one or more satellites to serve the terminal device before the predicted coverage window is to start;
a duration to be covered by the predicted coverage window;
a period after which the predicted coverage window is to start;
a timing after which the predicted coverage window is to start; or
a communication pattern of the terminal device.

20. The method of claim 18, further comprising:
transmitting to the network device, positioning information of the terminal device, the positioning information comprising at least one of the following:
current location information of the terminal device;
information on a current serving cell of the terminal device;
a mapped cell identifier of the current serving cell of the terminal device; or
a travel itinerary of the terminal device.

21-42. (canceled)
